(19) United States
(12) Patent Application Publication
(10) Pub. No.: US 2025/0163719 A1
(43) Pub. Date: May 22, 2025

(54) ATTACHMENT DEVICE FOR INSTALLING ON A VEHICLE ROOF

(71) Applicant: Thule Sweden AB, Hillerstorp (SE)

(72) Inventors: Anders NILVIUS, Värnamo (SE); David ARDMAR, Bankeryd (SE)

(21) Appl. No.: 18/839,012

(22) PCT Filed: Feb. 17, 2023
(86) PCT No.: PCT/EP2023/054053

§ 371 Date: Aug. 15, 2024

(30) Foreign Application Priority Data
Feb. 17, 2022 (DE) 10 2022 103 792.4

(51) Int. Cl. E04H 15/06; B60P 3/38; E04H 15/48; E04H 15/54

(52) U.S. Cl. CPC E04H 15/06; B60P 3/38; E04H 15/48; E04H 15/54

(57) ABSTRACT

Disclosed is an attachable device, such as a roof tent, for mounting on a vehicle roof. The attachable device may include two device sections configured to move relative to one another and extend transversely to the vehicle roof in the mounted state of the attachable device. Furthermore, the attachable device may include a traction means in mechanical operative connection with the two device sections. By pulling the traction means, the two device sections may move towards each other.

### CROSS REFERENCE TO RELATED APPLICATIONS

This application claims priority to PCT Application No. PCT/EP2023/054053, filed Feb. 17, 2023, which claims priority to DE Application No. 10 2022 103 792.4, filed Feb. 17, 2022, which are incorporated by reference herein in their entireties.

### TECHNICAL FIELD

The present disclosure relates to an attachable device for mounting on a vehicle roof. In particular, the attachable device may be a roof tent for accommodating people on a vehicle roof.

### BACKGROUND

There are various mechanisms for erecting and folding up roof tents. For example, U.S. Pat. No. 4,366,979 discloses a roof tent with a cord attached to the top for folding up the roof tent. WO 2013/066228 A1 relates to a transport box with a lower part, an upper part and an intermediate part made of a flexible material, wherein the intermediate part may be pulled into the middle of the transport box by means of drawstrings in order to close the transport box. Furthermore, roof structures of vehicles such as in CN 204 850 673 and KR 101 771 155, for example, may be closed by turning a mechanical component, such as a crank.

### SUMMARY

In a first aspect, the present disclosure relates to an attachable device for mounting on a vehicle roof. The attachable device may be a roof tent for accommodating people or a transport box for transporting goods. The attachable device may comprise an unfolded state and a folded state. In the unfolded state, it may be provided that the attachable device may accommodate people and/or goods. In the folded state, it may be provided that the attachable device can be transported on the vehicle roof, such as during driving of the vehicle. The vehicle roof may be the roof of a passenger car, a truck or another transport vehicle. For example, the vehicle roof may be the roof of an off-road vehicle. In some embodiments, the vehicle roof may also be the roof of a minibus, a coach or another vehicle roof. The attachable device may be mounted on the vehicle roof, and may be detachably mounted, using a mounting device. For example, the attachable device may be mounted on a roof rack mounted on the vehicle roof. The roof rack may be mounted on a roof rail, such as on two parallel roof rails of the vehicle. The roof rail may be a roof rail that may be integrated into the vehicle roof, a so-called “flush rail”, and/or a roof rail that is provided at a distance from the vehicle roof, a so-called “raised rail”.

The attachable device comprises two device sections that can be moved relative to each other and that may extend transversely to the vehicle roof when the attachable device is in a state mounted on the vehicle roof. The device sections may form sections of an outer shell of the attachable device. Alternatively or additionally, the device sections may be in mechanical operative connection with an outer shell of the attachable device. At least one of the device sections may be formed in such a way that it can be mounted on the vehicle roof. The attachable device may be opened or closed by moving the device sections relative to each other. The device sections may be moved translationally and/or rotationally towards or away from each other when opening and closing the attachable device. When the attachable device is mounted, it may be provided that one of the two device sections is mounted on the vehicle roof, for example on a luggage carrier of the vehicle roof. The vehicle roof may comprise a longitudinal extension direction in the direction of travel of the vehicle and a transverse extension direction which extends transversely, for example orthogonally, to the longitudinal extension direction.

The attachable device further comprises a traction member, which may be in mechanical operative connection with the two device sections. The traction member may have a longitudinal extension along which the traction member can be gripped and pulled by a user. The traction member may be rigid or flexible. The traction member may be in direct mechanical operative connection with the device sections, for example via a shaped and/or recessed section of the device sections designed for this purpose. Alternatively, the traction member may be in contact with a connecting element, such as an eyelet, a roller element or an extension attached to the device sections. The connecting element may in turn be connected to the device sections. Thus, the traction member may be in indirect mechanical operative connection with the device sections via the connecting element. By pulling of the traction member by a user standing on the ground next to the vehicle, the two device sections are moved towards each other. Here, the traction member may be gripped and pulled by a user, for example along its longitudinal extension. As a result, a section of the traction member located between the device sections may be shortened, allowing the device sections to be moved towards each other. In some embodiments, the user may stand next to the vehicle at the height of the vehicle doors. Depending on the length of the traction member, the user standing on the ground may comprise a distance of, for example, 0.1 m, 0.5 m, 0.8 m, 1 m or 2 m from the vehicle when pulling the traction member.

The user's pulling direction may be divided into several directional components, for example a horizontal, a vertical and a resultant direction. The horizontal direction may coincide with the transverse direction of the vehicle roof. When pulling the traction member transverse to the vehicle roof, the resulting traction direction has a directional component transverse to the vehicle roof but may also comprise other directional components. For example, the pulling may take place at an angle to the vehicle roof. In some embodiments, the device sections are moved towards each other when the traction member is pulled by the user transversely to the vehicle roof or even in an arbitrary direction.

The attachable device of the present disclosure may be closed easily and efficiently by a user. In some embodiments, the present disclosure may allow the attachable device to be closed also when the user is standing on the ground next to the vehicle. As a result, the handling comfort of the attachable device for the user may be increased.

According to one embodiment, the device sections move parallel towards one another in a sectional plane by pulling the traction member. The sectional plane runs normal to the vehicle roof and may be arranged in the transverse or longitudinal direction of the vehicle roof. The device sections may move parallel to each other in the sectional plane during their entire relative movement, for example during the complete closing and/or opening process of the attachable device. In some embodiments, the device sections do not tilt relative to each other in the cutting plane during the closing process. The device sections may be moved towards each other in a translational and/or rotational manner.

According to a further embodiment, the attachable device further comprises a diverting element for diverting the traction member, which is arranged at one of the device sections. The diverting element may be arranged and designed on the device section in such a way that the traction member changes its direction of extension along the attachable device by interacting with the diverting element. The diverting element may, for example, be an eyelet through which the traction member can slide. Alternatively, the diverting element may, for example, be a roller over which the traction member is guided. By means of the diverting element, the mechanical operative connection between the traction member and the device section may be established in a simple manner. The diverting element leads to relatively large forces and therefore allows comfortable handling.

According to a further embodiment, the attachable device also comprises a further diverting element for diverting the traction member, which is arranged at the other device section. The further diverting element may be designed analogously to the diverting element. In some embodiments, the diverting element and the further diverting element may be arranged at a predetermined distance and/or a predetermined orientation relative to one another on the respective device sections. This may facilitate the pulling of the traction member for the user and/or the movement of the device sections relative to each other. In one embodiment, the attachable device comprises only the two and no further diverting elements. The two diverting elements lead to large vertical forces and thus allow comfortable handling.

According to a further embodiment, the traction member is fixed to one of the device sections, such as to an end section of the device section, and runs along both diverting elements. An end section of the device section may designate the area that outwardly limits the device section, such as along its direction of extension. The traction member may, for example, be riveted, glued, clamped or screwed to the device section and/or held in a fixing element arranged on the device section. The traction member may be fixed to the device section facing away from the vehicle roof. Through this arrangement, a course or path of the traction member relative to the two device sections may be specified.

According to a further embodiment, the diverting element and/or the further diverting element are arranged on the respective device section such that, by pulling the traction member by the user, the device sections can be moved towards each other such that they are arranged parallel to each other in the sectional plane as described above. For example, the device sections may be translationally moved towards each other. In this embodiment, the diverting elements may, for example, be arranged relative to each other and relative to the fixation on the device section in such a way that only vertical forces act on the device section facing away from the vehicle roof, for example by compensating for the horizontal force components. This arrangement of the diverting elements prevents the device sections from tilting relative to each other, for example in the cutting plane, when the traction member is pulled.

According to a further embodiment, the traction member is a flexible, such as an element which can be rolled up, or a belt and/or rope. The traction member may be rolled up in such a way that it may be folded up essentially circularly along its longitudinal extension. The rope may comprise a symmetrical, for example round or square, cross-section. The rope may be a rope made of synthetic or natural fibers or a wire rope or both. The traction member may also be a chain. The traction member may be a belt, for example, if the traction member comprises a generally rectangular cross-section. Due to the flexibility of the traction member, it may be brought into mechanical operative connection with the device sections in a simple manner. Alternatively, the traction member may also be an element that cannot be rolled up, for example rod elements that can be moved relative to one another, which may be formed from metal or plastic or both.

According to a further embodiment, the device sections are delimiting surfaces, such as an upper side and a lower side, of the attachable device, which for example are arranged parallel to each other in the folded and/or unfolded state of the attachable device. The device sections may be delimiting surfaces, for example, if they form an outer shell of the attachable device, at least in sections. It may be provided that the lower side of the attachable device can be connected to the vehicle roof, such as mounted on it, for example by means of a roof rack. Furthermore, it may be provided that the upper side is arranged above the lower side in a direction perpendicular to the vehicle roof. By pulling the traction member, the delimiting surfaces of the attachable device are moved towards each other, whereby the attachable device can be closed in a simple manner. The delimiting surfaces may only be moved towards each other on one side, for example the front side, when pulling the traction member. Alternatively, the delimiting surfaces may be moved towards each other as a whole. The delimiting surfaces may thereby be moved parallel to each other. Alternatively or additionally, the boundary surfaces may be pivoted relative to each other.

According to a further embodiment, the device sections are substantially solid. For this purpose, the device sections may be formed from a solid material that does not deform under its own weight. The device sections may also be reinforced so that they do not deform under their own weight. The device sections may be made of plastic, for example. They may be reinforced by a frame. A foldable material may be provided between the device sections. A foldable material may be a material that deforms due to its own weight. The foldable material may be a fabric, for example a tent fabric. Due to the foldable material, the attachable device may be compactly folded for transportation purposes and at the same time easily unfolded to accommodate objects or people. In the folded state, the device sections may lie against each other, whereby the foldable material may be accommodated in an interior space spanned by the device sections.

According to one embodiment, the foldable material comprises a window and/or access surface. In this embodiment, the attachable device comprises a retaining element which pulls the traction member away from the window and/or access surface in the non-actuated state. A window surface of the foldable material may be understood to be a section of the same which is at least partially transparent, such as to visible light, or partially transparent in both directions. For example, the window surface may be a recess in the foldable material, which is covered with a transparent material. An access surface of the foldable material may be understood as a recess therein through which a user gains access to an interior of the attachable device. The access surface may be closed using a zipper system, for example. The retaining element may, analogously to the traction member, be flexible, and in some embodiment may be able to be rolled up. The retaining element may be an elastically deformable element that acts as a spring. For example, the retaining element may be fixed to an end section of one of the device sections and pretension the traction member in the direction of this end section when not actuated, so that it is pulled away from the window and/or access surface. This design may make it easier for a user to see through the window surface or access the interior of the attachable device.

According to a further embodiment, the attachable device is also equipped with a pretensioning device by means of which the device sections are held at a predetermined distance from one another. The pretension of the pretensioning device can be overcome by pulling the traction member. The pretensioning device may, for example, be a hinge arranged between the device sections, which can be held at a predetermined opening angle by means of a spring force. Alternatively or additionally, the pretensioning device may be rod elements that are arranged between the device sections and can be displaced relative to each other, which can be held at a predetermined length by means of a spring force. Other forms of pretensioning elements are also conceivable. By pulling the traction member, a force may be applied to the device sections which counteracts the pretensioning force, for example the spring force of the hinge. The attachable device may thus be pretensioned into an open state by means of the pretensioning device. By pulling the traction member, the attachable device may be transferred to a closed state against the pretensioning force.

In a second aspect, the present disclosure relates to a method for closing an attachable device mounted on a vehicle roof, such as an attachable device according to the first aspect described above. In some embodiments, the attachable device comprises a traction member according to the first aspect. The method comprises pulling of the traction member by a user standing on the ground next to the vehicle, such as in a direction transverse to the vehicle roof, or in any direction, for moving the two device sections of the attachable device towards each other. The method may be used to close the attachable device on a first side. The attachable device may then be closed on a further side, for example an opposite side, using the same method. The other side may also be closed in a different way. Furthermore, in one embodiment, all sides of the attachable device are closed simultaneously by means of the method by pulling the traction member. For example, the upper and lower sides of the attachable device may be moved towards each other in parallel by pulling the traction member to close all sides at the same time.

### BRIEF DESCRIPTION OF THE DRAWINGS

FIG. 1a schematically shows an attachable device in the form of a roof tent according to one embodiment of the present disclosure.

FIG. 1b illustratively shows the roof tent of FIG. 1a without foldable material between the upper and lower sides.

FIG. 2 illustratively shows a front view of the roof tent of FIGS. 1a and 1b.

FIG. 3 illustratively shows the roof tent of FIGS. 1a and 1b according to a furthe embodiment of the present disclosure.

FIG. 4a illustratively shows an alternative embodiment of the roof tent.

FIG. 4b illustratively shows another alternative embodiment of the roof tent.

FIG. 4c illustratively shows an attachable device in the form of a transport box according to a further embodiment of the present disclosure.

FIG. 5 illustratively shows a flowchart with steps of a method for closing an attachable device according to an embodiment of the present disclosure.

### DETAILED DESCRIPTION

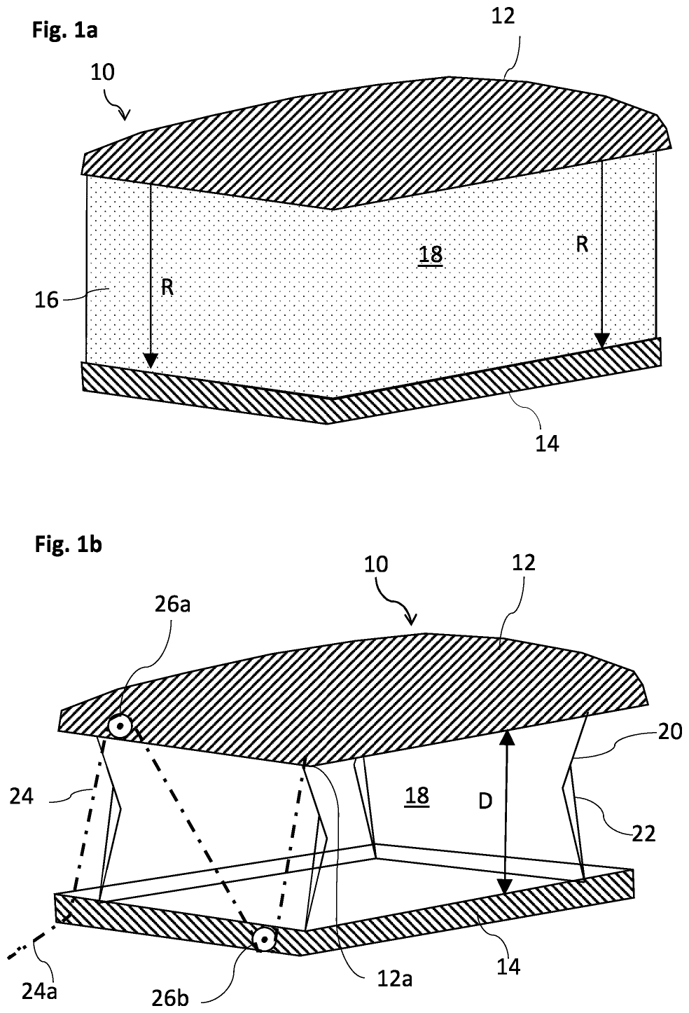

FIG. 1a schematically shows an attachable device in the form of a roof tent 10 according to an embodiment of the present disclosure. The roof tent 10 is used to accommodate people and may be mounted on a vehicle, which is not shown. In an embodiment which is not shown here, the attachable device may also be a transport box for holding and transporting objects, such as luggage or sports articles. The transport box may also be mounted on a vehicle roof analogously to the roof tent 10.

The roof tent 10 comprises at least two device sections 12, 14. In the embodiment of FIG. 1a, the device sections 12, 14 are shown as oppositely arranged delimiting surfaces, which delimit the roof tent 10 outwardly, at least in sections. As shown as an example in the embodiment of FIG. 1a, the device sections 12, 14 may, for example, be an upper side 12 and a lower side 14 of the roof tent 10. The lower side 14 of the roof tent 10 may be mounted on the vehicle roof, for example on a roof rack, which is not shown. In the embodiment shown, the device sections 12, 14 are formed from a solid material and are movable relative to one another. The upper side 12 and the lower side 14 of the roof tent 10 are rectangular and formed with essentially the same size.

A foldable material 16 is arranged between the device sections 12, 14. The embodiment of FIG. 1a shows the roof tent 10 in an unfolded state. An interior 18 of the roof tent 10 is delimited by the device sections 12, 14 and the foldable material 16 in the unfolded state. People and/or objects may be accommodated in the interior 18 of the roof tent 10. The device sections 12, 14 may be moved towards each other in the direction of arrow R to fold up the roof tent, whereby the foldable material 16 is folded up. This movement may bring the roof tent 10 into a folded state, which is not shown. In the folded state, the roof tent 10 may be transported, for example on the vehicle roof while the vehicle is being driven.

FIG. 1b shows the roof tent 10 in the unfolded state, but without the foldable material 16. As can be seen from the illustration in FIG. 1b, pretensioning device 20 are arranged between the upper side 12 and the lower side 14 of the roof tent 10 to maintain the unfolded state. The pretensioning device 20 are shown in the illustration of FIG. 1b in the form of hinges 20, which define a predetermined opening angle by means of a spring element 22. The hinges 20 may be used to hold the upper side 12 and the lower side 14 at a predetermined distance D. The roof tent comprises a total of four pretensioning device 20, which are arranged at the respective corners of the roof tent.

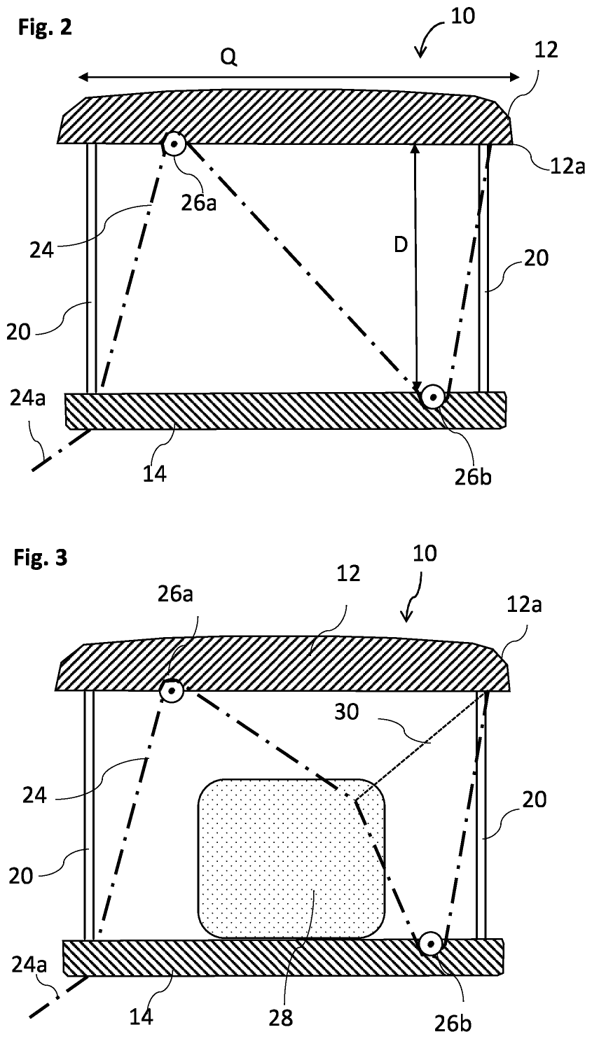

Furthermore, in the embodiment shown in FIG. 1b, the roof tent 10 comprises a traction member 24 and two diverting elements 26a, 26b. In the embodiment, the traction member 24 is in the form of a belt 24 which can be rolled up. The traction member 24 is fixed to an end section 12a of the upper side 12 of the roof tent 10, in the present embodiment to the front side of the roof tent. Starting from the end section 12a of the upper side 12, the traction member 24 extends between the device sections 12, 14 and changes its direction of extension in each case by diverting at the diverting elements 26a, 26b. Finally, the traction member 24 protrudes from the lower side 14 of the roof tent 10 with an excess length 24a. In the present embodiment, this excess length 24a is provided on the lower side 14 diagonally opposite to the fixation of the traction member 24 on the upper side 12. This excess length 24a of the traction member 24 may be gripped by a user, such as a driver of the vehicle, and used to pull the traction member 24. The arrangement and operation of the traction member 24 is explained in more detail with reference to FIG. 2.

FIG. 2 shows a schematic front view of the roof tent 10 of FIGS. 1a and 1b. As can be seen from the representation in FIG. 2, the traction member 24 runs between the upper side 12 and the lower side 14 of the roof tent 10. One of the diverting elements 26a and 26b is arranged on the upper side 12 and the lower side 14 respectively. In FIG. 2, the diverting elements 26a and 26b are shown as rollers over which the traction member 24, shown as a belt, is tensioned. Furthermore, the traction member 24 is fixed to an end section 12a of the upper side 12 of the roof part 10.

Due to the fixation of the traction member 24 at the end section 12a and the diversion at the rollers 26a, 26b, a resulting force is applied to the upper side 12 when the traction member 24 is pulled. The arrangement of the diverting elements 26a, 26b is such that the resulting force F is a force acting in a vertical direction. In the illustration in FIG. 2, the rollers 26a, 26b are arranged on the upper side 12 or the lower side 14 of the roof tent 10 in such a way that the horizontal components of the forces acting on the upper side 12 cancel each other out. As a result, the distance D between the upper side 12 and the lower side 14 is uniformly reduced along the front surface of the roof tent, which extends in the transverse direction Q of the vehicle roof. In other words, the arrangement of the rollers 26a and 26b shown in FIG. 2 prevents the device sections 12, 14 from tilting relative to each other in a sectional plane which is arranged normal to the vehicle roof and extends parallel to the transverse direction Q when the traction member 24 is pulled. The device sections 12, 14 thus move towards each other in this sectional plane in such a way that they are always arranged parallel during the relative movement. As already mentioned in connection with the embodiment of FIG. 1b, the traction member 24 protrudes with an excess length 24a from the lower side 14 of the roof tent 10. At this excess length 24a, a user standing next to the vehicle may grip the traction member 24 and pull it in any direction. The user does not thereby have to climb onto the vehicle but may pull the traction member 24 while standing next to the vehicle. Closing the roof tent 10 is thus made easier for the user by the present disclosure.

FIG. 3 shows the roof tent 10 according to a further development. Here, a window surface 28 is provided in the foldable material 16. The window surface 28 is in the form of a recess in the foldable material 16, which is covered with a material that is transparent to visible light. For example, the recess in the foldable material 16 may be covered with a grid mesh. The user may look out of the interior 18 of the roof tent 10 through this grid mesh. At the same time, the grid mesh may prevent dirt and/or insects from entering the interior 18 of the roof tent 10. Alternatively or additionally, the roof tent 10 may also be provided with an access surface through which the user can gain access to the interior 18 of the roof tent 10.

To improve the user's view through the window surface 28, the roof tent 10 according to the embodiment of FIG. 3 is further provided with a retaining element 30. The retaining element 30 is shown in FIG. 3 in the form of a flexible strap, which is in mechanical operative connection with the traction member 24. The strap 30 is fixed to the end section 12a of the upper side 12 of the roof tent 10. If the traction member 24 is not pulled, the retaining element 30 pretensions the traction member 24 in the direction of the end section 12a. As a result, the traction member 24 is largely pulled out of the window surface 28. The user's field of vision is thus barely impaired by the traction member 24 when looking through the window surface 28 due to the retaining element 30.

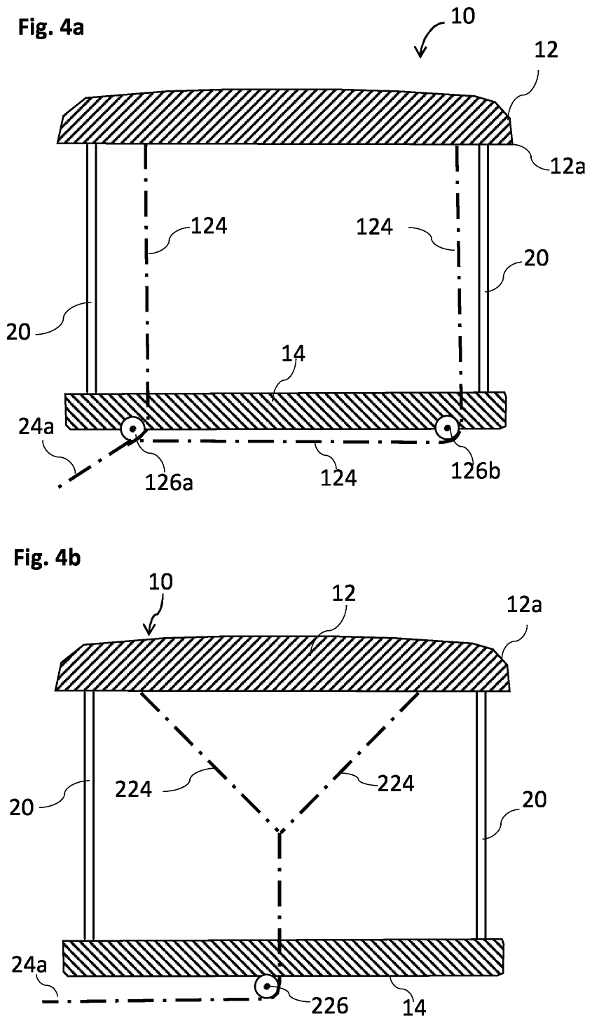

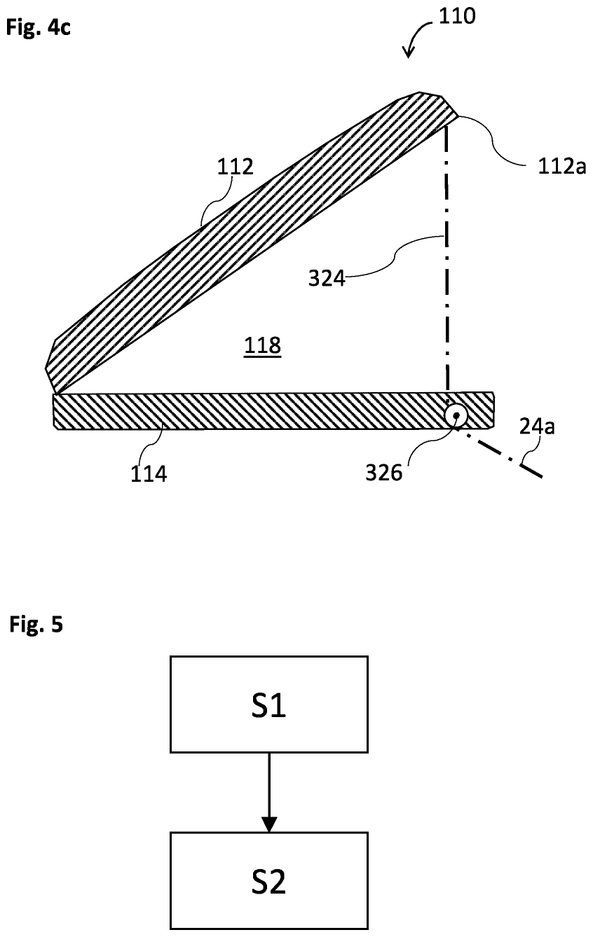

FIGS. 4a to 4c show further embodiments of attachable devices according to the present disclosure. Identical reference signs denote identical elements.

FIG. 4a shows a roof tent 10 according to a further embodiment. In contrast to the embodiment of FIGS. 1a to 3, in the embodiment of FIG. 4a two diverting elements in the form of rollers 126a, 126b are arranged on the outside of the lower side 14 of the roof tent 10 facing the vehicle roof. A traction member 124 is fixed at two points on the upper side 12 of the roof tent 10 and is diverted at the rollers 126a, 126. The diverted traction member 124 protrudes with the excess length 24a from the lower side 14 of the roof tent 10. Otherwise, the roof tent of the embodiment of FIG. 4a is formed analogously to the roof tent 10 according to the embodiments of FIGS. 1a to 3.

FIG. 4b shows a roof tent 10 according to a further embodiment. In contrast to the embodiments of FIGS. 1a to 3, in the embodiment of FIG. 4b a diverting element in the form of a roller 226 is arranged centrally on the lower side 14 of the roof tent 10 facing the vehicle roof. A traction member 224 is fixed at two points on the upper side 12 of the roof tent 10 and is diverted at the roller 226. The diverted traction member 224 protrudes with the excess length 24a from the lower side 14 of the roof tent 10. Otherwise, the roof tent of the embodiment of FIG. 4b is formed analogously to the roof tent 10 according to the embodiments of FIGS. 1a to 3.

FIG. 4c shows an attachable device in the form of a transport box 110 according to a further embodiment. The transport box is designed to hold objects, such as luggage or sports articles, for example skis, and comprises an upper side 112 and a lower side 114. The upper side 112 and the lower side 114 of the transport box 110 are pivotably connected relative to each other at one end section along a longitudinal side of the box by means of a connecting element, which is not shown. At the opposite end section along the longitudinal side, the upper side 112 and the lower side 114 are not connected to each other. In the embodiment of FIG. 4c, the transport box 110 is open on one side to allow a user access to the interior 118 of the transport box 110.

A diverting element in the form of a roller 326 is arranged on the lower side 114 of the transport box 110. A traction member 324 is fixed to an end portion 112a of the upper side 112 of the transport box 110. The traction member 324 is diverted at the roller 324 and protrudes with the excess length 24a from the lower side 114 of the transport box 110. The traction member may be gripped at this excess length 24a by a user standing next to the vehicle and pulled in any direction. By pulling the traction member 324, the upper side 112 and the lower side 114 are moved towards each other in such a way that they are arranged parallel to each other in a sectional plane, which is arranged normal to the vehicle roof, i.e. perpendicular to the plane of the sheet, and runs in the longitudinal direction of the vehicle roof.

FIG. 5 shows a flowchart with steps of a method for closing an attachable device mountable on a vehicle roof according to an embodiment of the disclosure. The attachable device is designed according to one of the embodiments of FIGS. 1a to 4c. In some embodiments, the attachable device comprises a traction member according to the embodiments of FIGS. 1a to 4c.

The method begins with pulling S1 of the traction member by a user standing on the ground next to the vehicle, such as in a direction transverse to the vehicle roof, or in any direction, to move the two device sections on one side of the attachable device towards each other. The method further comprises moving S2 of the two device sections towards each other on a second side, which may be opposite the first side, of the attachable device. The first side may be arranged above a windshield of the vehicle. The first side is therefore only accessible to the user with difficulty. The second side may be arranged above a rear or trunk of the vehicle. The second side of the attachable device is therefore easier for the user to reach than the first side. The implementation of the method enables the user to close the attachable device mounted on the vehicle roof on the first side without having to climb onto the vehicle.

### REFERENCE SIGNS

10; 110 attachable device; roof tent; transport box
12; 112 device section; upper side
14; 114 device section; lower side
12a end sections of the device section
16 foldable material
18; 118 interior of the attachable device
20 pretensioning device; hinges
22 spring element of the pretensioning device
24; 124; 224; 324 traction member
24a excess length of the traction member
26a; 26b; 126a, 126b; 226; 326 diverting elements; rollers
28 window surface
30 retaining element
R direction of movement of the device sections
D distance between the device sections
Q Transverse extension direction

1.-12. (canceled)

13. An attachable device, for a roof tent, for mounting on a vehicle roof, comprising:
two device sections configured to move relative to one another and extend transversely to the vehicle roof in a mounted state of the attachable device; and
a traction member configured to be in mechanical operative connection with the two device sections,
wherein the two device sections are configured to be moved towards each other by pulling the traction member by a user standing on the ground next to the vehicle.

14. The attachable device of claim 13, wherein the traction member is configured to be pulled in a direction transverse to the vehicle roof.

15. The attachable device of claim 13, wherein the traction member is configured to be pulled in an arbitrary direction relative to the vehicle roof.

16. The attachable device of claim 13, wherein the two device sections are configured to move parallel towards one another in a sectional plane, wherein the sectional plane is arranged perpendicular to the vehicle roof and extends in a transverse or longitudinal direction of the vehicle roof, by pulling the traction member.

17. The attachable device of claim 13, further comprising a first diverting element for divert-ing the traction member, wherein the first diverting element is arranged at one of the two device sections.

18. The attachable device of claim 17, further comprising a second diverting element config-ured to divert the traction member, wherein the second diverting element is arranged at the other device section of the two device sections.

19. The attachable device of claim 17, wherein the traction member is fixed to one of the two device sections, and runs along the first diverting element and the second diverting element.

20. The attachable device of claim 19, wherein, the traction member is fixed to an end section of one of the two device sections.

21. The attachable device of claim 19, wherein the first diverting element, the second divert-ing element, or both are arranged on the respective device section such that, by pulling the traction member by the user, the two device sections can be moved towards each other such that they are arranged parallel to each other in the sectional plane.

22. The attachable device of claim 13, wherein the traction member is a flexible element.

23. The attachable device of claim 22, wherein the flexible element is configured to be rolled up.

24. The attachable device of claim 22, wherein the flexible element is a belt, a rope, or both.

25. The attachable device of claim 13, wherein the two device sections are two delimiting sur-faces of the attachable device, wherein the two delimiting surfaces comprise an upper side and a lower side.

26. The attachable device of claim 13, wherein the two device sections are formed of a solid material and wherein a foldable material is provided between the two device sections.

27. The attachable device of claim 26, wherein the foldable material comprises a window, an access surface, or both, and wherein the attachable device further comprises a retaining element configured to pull the traction member away from the window or access surface in a non-actuated state.

28. The attachable device of claim 13, further comprising a pretensioning device configured to hold the two device sections at a predetermined distance from one another, wherein the pretensioning of the pretensioning device can be overcome by pulling of the traction member.

29. A method for closing an attachable device mounted on a vehicle roof, comprising:
pulling a traction member of the attachable device; and
moving two device sections of the attachable device towards each other.

30. The method of claim 29, wherein the traction member are pulled in a direction transverse to the vehicle roof.

31. The method of claim 29, wherein the traction member are pulled in an arbitrary direction relative to the vehicle roof.

32. The method of claim 29, wherein pulling the traction member is by a user standing on the ground next to the vehicle.
